(19) United States
(12) Patent Application Publication
(10) Pub. No.: US 2008/0124156 A1
(43) Pub. Date: May 29, 2008

(54) Toner Detection Window Cleaning Apparatus

(76) Inventors: Samuel Tsui, Hong Kong (CN); Pater Zhang, Shen Zhen City (CN)

Correspondence Address: BERENATO, WHITE & STAVISH, LLC, 6550 ROCK SPRING DRIVE, SUITE 240, BETHESDA, MD, 20817, US

(21) Appl. No.: 11/795,971

(22) PCT Filed: Jan. 25, 2006
(86) PCT No.: PCT/AU06/00080

§ 371 Date: Jul. 25, 2007

(30) Foreign Application Priority Data
Jan. 25, 2005 (AU) 2005900311

(51) Int. Cl. G03G 21/00

(52) U.S. Cl. 399/351

(57) ABSTRACT

A toner detection window cleaning apparatus 100 comprising a cleaning arm 104 having a first protruding arm 118a and a second protruding arm 118b substantially opposite the first protruding arm 118a, the first protruding arm having a radial through slot 120 provided therein and the second protruding arm 118b having a cleaning member 122 attached thereto; a rotatable shaft 20 having at least a portion thereof adapted to be received in, and extend through, a portion of the cleaning arm 104; and a flange 106 integrally formed with the rotatable shaft 20, the flange 106 having a pin 108 extending therefrom in a direction substantially parallel to the rotatable shaft 20, where, the pin 108 is received within the radial through slot 120 and where, when the toner detection window cleaning apparatus 100 is inserted into a cartridge having a toner detection window, the cleaning member 122 scrapes against at least a substantial portion of the toner detection window during at least part of one rotation of the rotatable shaft 20.

### FIELD OF THE INVENTION

The invention relates to a toner detection window cleaning apparatus for a process cartridge. The invention is applicable to process cartridges engaged for use with any electrophotographic image forming device, including laser printers, laser photocopiers and laser facsimile machines. While the invention is not limited to such use, the invention will be described in the context of its use within a process cartridge that engages with a laser printer.

### BACKGROUND TO THE INVENTION

The following discussion of the background of the invention is intended to facilitate an understanding of the present invention. However, it should be appreciated that the discussion is not an acknowledgment or admission that any of the material referred to was published, known or part of the common general knowledge in any jurisdiction as at the priority date of the application.

Developer cartridges may include a toner level sensing means for sensing the level of toner in the toner reservoir. In some such cartridges, the resistance of the toner to electrical current is used as the basis for determining the toner level. In other cartridges, optical means are used as the basis for determining the toner level.

In this latter arrangement, optical analysis of the toner level is almost unanimously facilitated by a window in the developer cartridge frame (or a similar lens arrangement). The inclusion of the window, however, means that it is often necessary for the developer cartridge to also include cleaning mechanisms to clean the toner level window.

In some developer cartridges the cleaning mechanism employed takes the form of a blade attached to an agitator located within the toner reservoir. The blade rotates coaxially with the agitator. Thus, in order for the blade to be correctly aligned with the toner level window, great care must be taken in aligning the agitator. Further, if the blade is integral with the agitator, both the blade and agitator must be replaced if either component fails or becomes worn.

It is therefore an object of the present invention to create a toner detection cleaning apparatus that overcomes, or at least lessens, one or more of the disadvantages of the stated prior art.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the invention there is a toner detection window cleaning apparatus comprising:
a cleaning arm having a first protruding arm and a second protruding arm substantially opposite the first protruding arm, the first protruding arm having a radial through slot provided therein and the second protruding arm having a cleaning member attached thereto
a rotatable shaft having at least a portion thereof adapted to be received in, and extend through, a portion of the cleaning arm; and
a flange integrally formed with the rotatable shaft, the flange having a pin extending therefrom in a direction substantially parallel to the rotatable shaft,
   where, the pin is received within the radial through slot and where, when the toner detection window cleaning apparatus is inserted into a cartridge having a toner detection window, the cleaning member scrapes against at least a substantial portion of the toner detection window during at least part of one rotation of the rotatable shaft.

The cleaning member may be “L”-shaped.

The rotatable shaft also has a toner agitator attached thereto. In this configuration, the flange may also have a connecting lug to which a helical agitating wire connects at a first end.

In accordance with a second aspect of the present invention there is a cartridge including a toner detection window cleaning apparatus according to the first aspect of the invention.

### BRIEF DESCRIPTION OF THE DRAWINGS

The Invention will now be described, by way of example only, with reference to the accompanying drawings, in which:

FIG. 1 is an isometric view of a common process cartridge.

FIG. 2a is a first isometric view of an agitator incorporated into the present invention.

FIG. 2b is a second isometric view of the agitator shown in FIG. 2a.

FIG. 3a is a first isometric view of a toner detection cleaning arm as incorporated into the present invention.

FIG. 3b is a second isometric view of the toner detection cleaning arm shown in FIG. 3a.

FIG. 4a is a first plan view of a toner detection cleaning apparatus according to the present invention.

FIG. 4b is a second plan view of the toner detection cleaning apparatus shown in FIG. 4a.

FIG. 4c is a third plan view of the toner detection cleaning apparatus shown in FIG. 4a.

FIG. 5 is a cut-away view of a process cartridge incorporating the toner detection cleaning apparatus shown in FIG. 4a.

FIG. 6 is a view of a process cartridge incorporating the toner detection cleaning apparatus shown in FIG. 4a with the cartridge top removed.

FIG. 7 is a series of views of the toner detection cleaning apparatus shown at different stage of operation.

### PREFERRED EMBODIMENTS OF THE INVENTION

In order to properly describe the preferred embodiment of the invention, it is necessary to describe a typical process cartridge 10 in which the invention will operate.

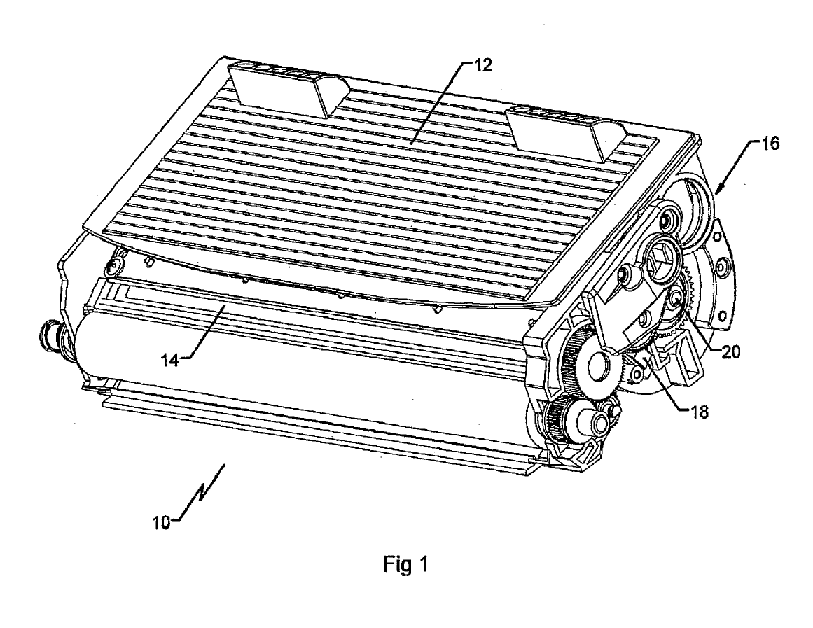

FIG. 1 shows the process cartridge 10. The process cartridge 10 has a toner reservoir 12. Toner (not shown) is stored in the toner reservoir 12 ready for transfer to the developing roller 14.

At each longitudinal end 16 of the toner reservoir 12 is a window 18. The window 18 is offset from the transverse centre of the toner reservoir 12 and is located in a lower half of the toner reservoir 12. The window 18 includes a lens (not shown).

Also shown in FIG. 1 is a shaft 20. The role of the shaft will be explained in more detail below.

The preferred embodiment of the invention will now be described.

The preferred embodiment of the invention takes the form of a toner detection cleaning apparatus 100. The toner detection cleaning apparatus 100 comprises an agitator 102 and two cleaning arms 104. Both the agitator 102 and cleaning arm 104 are located within the confines of the toner reservoir 12.

The agitator 102 is built around shaft 20. As has been shown in FIG. 1, the shaft 20 passes through the ends 16 of the toner reservoir 12, thus maintaining the shafts 20 position during rotation.

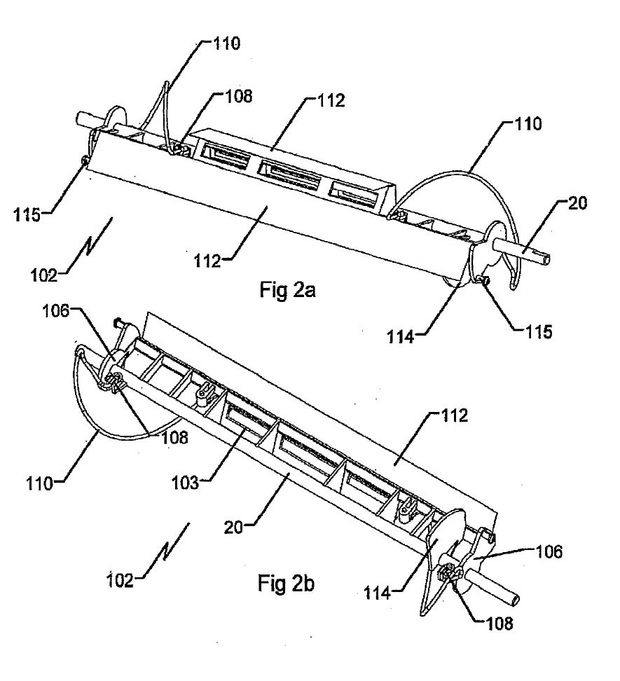

Attached to the shaft 20 is a supporting platform 105 bounded by two circular flanges 106. Also attached to the shaft 20, at a position substantially opposite the supporting platform 105 and adjacent the circular flanges 106, are connecting lugs 108. Helical agitating wires 110 extend from each connecting lug 108 to separate positions on the supporting platform 103 (see FIGS. 2a and 2b).

Also connected to the supporting platform 103 are two agitating blades 112 and a shielding member 114. Each agitating blade 112 is substantially rectangular in shape. The two agitating blades 112 are circumferentially spaced relative to the shaft 20. In this embodiment, the agitating blades 112 are positioned such that the exposed edge of the agitating blades 112 is equal to or slightly less than the inner radius of the toner reservoir 12.

The shielding member 114 is located at one end of the shaft 20. In the embodiment shown in FIGS. 2a and 2b, the shielding member 114 is positioned in close proximity to a lug 108 and arranged such that the lug 108 is interposed between the shielding member 114 and the circular flange 106 at that end.

Extending from each circular flange 106, in a direction parallel to the shaft 20 and away from the supporting platform 105, is a pin 115. The role of the pin 115 will be described in more detail below.

Each cleaning arm 104 has a cylindrical main body 116. Integrally formed with the cylindrical main body 116 are two protruding arms 118a, 118b. The protruding arms are substantially opposite one another relative to the rotational axis X of the cylindrical main body 116.

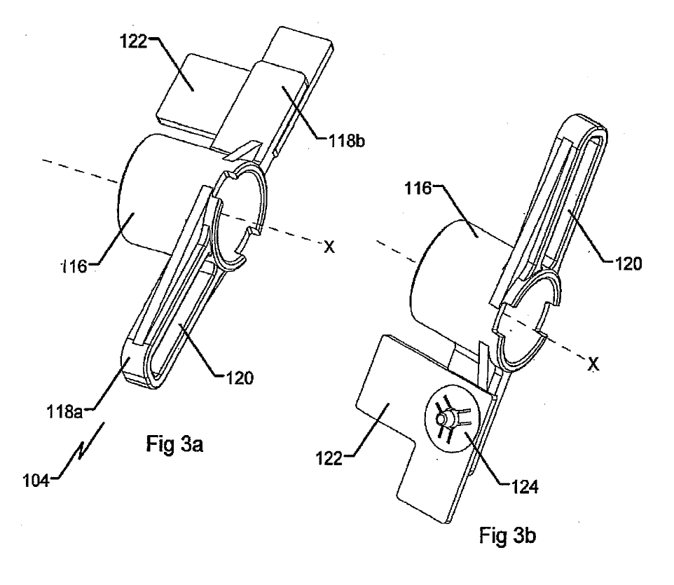

Protruding arm 118a has a radial through slot 120 provided therein. Protruding arm 118b has a cleaning member 122 connected thereto. As shown in FIG. 3b, the cleaning member 122 in the embodiment described is “L”-shaped and arranged such that the longer portion of the cleaning member 122 is parallel to the rotational axis X of the cylindrical main body 116.

The cleaning member 122 is connected to the protruding arm 118b by way of a fastening clip 124.

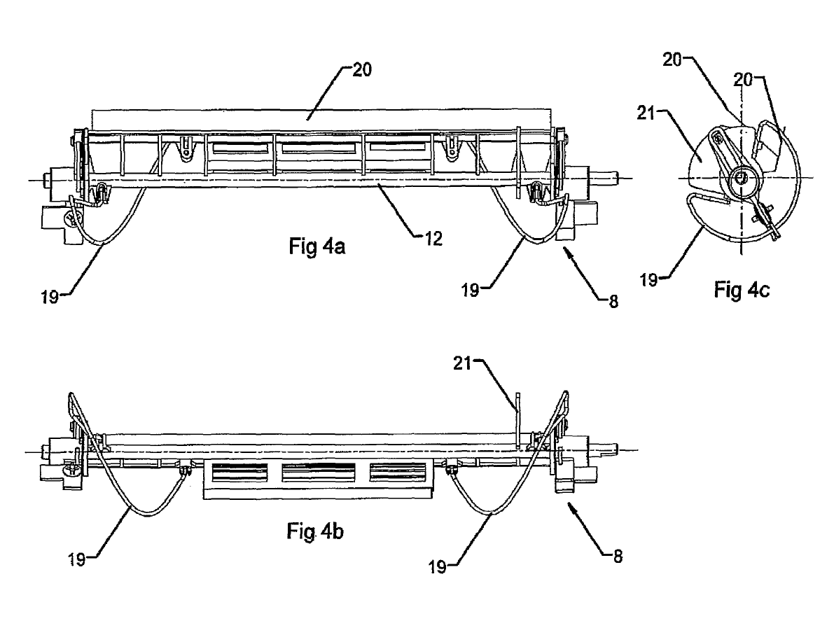

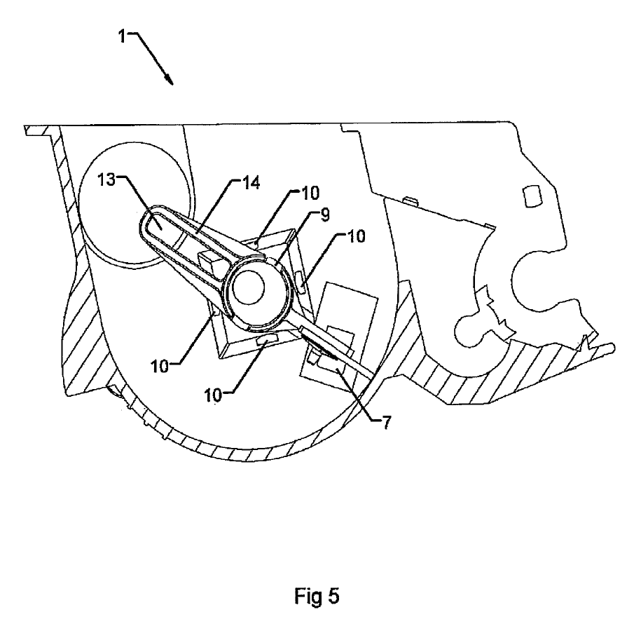

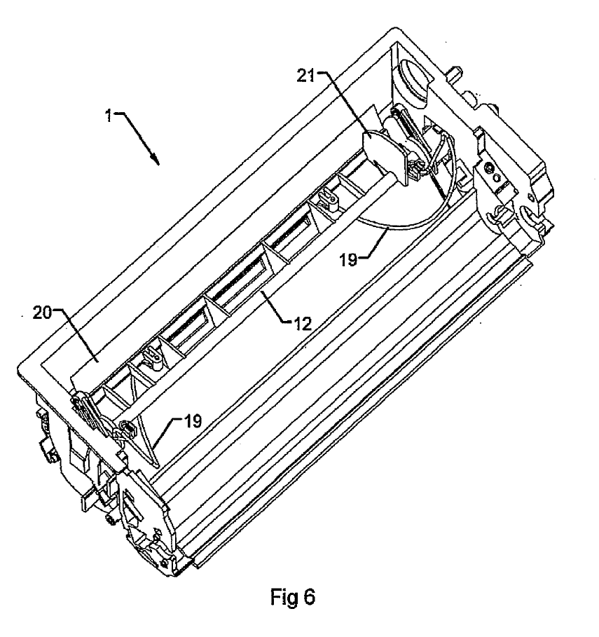

As shown in FIGS. 4a and 4b, each cleaning arm 104 is positioned to engage the agitator 102. This engagement is formed by the reception of the shaft 20 within the cylindrical main body 116. Each cleaning arm 104 is placed adjacent a circular flange 106 such that the pin 115 is received within the through slot 120.

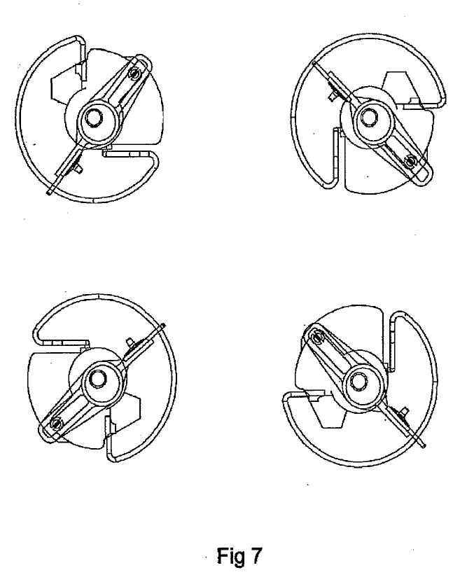

FIG. 7 shows the cleaning arm 104 in use.

It should be appreciated by the person skilled in the art that the above invention is not limited to the embodiment described. In particular, the following modifications and improvements may be made without departing from the scope of the present invention:
The agitating blades 112 may be positioned such that the exposed edge of the agitating blades 112 is radially longer than the inner radius of the toner reservoir 12. This allows for deformation of the exposed edge of the agitator blades 112 against the interior walls of the toner reservoir 12 in a manner that facilitates the scraping of toner from the interior walls.
In embodiments where the agitating blades 112 are radially longer than the inner radius of the toner reservoir 12, the front wall of the toner reservoir 12 may be angled away from the agitator so that the space between the shaft 20 and the interior walls of the toner reservoir 12 increases. This assists in preventing the agitating blades 112 from flicking toner through a toner opening towards the developing roller 14 as the agitating blades 112 pass the toner opening.
While the invention has been described in the context of a process cartridge, the invention may be applied to other cartridge types, such as a developer cartridge.

It should be further appreciated by the person skilled in the art that the features described in one embodiment, where not mutually exclusive or alternatives, may be combined with features described in other embodiments to create yet further embodiments that fall within the scope of the present invention.

1. A toner detection window cleaning apparatus comprising:
a cleaning arm having a first protruding arm and a second protruding arm substantially opposite the first protruding arm, the first protruding arm having a radial through slot provided therein and the second protruding arm having a cleaning member attached thereto;
a rotatable shaft having at least a portion thereof adapted to be received in, and extend through, a portion of the cleaning arm; and
a flange integrally formed with the rotatable shaft, the flange having a pin extending therefrom in a direction substantially parallel to the rotatable shaft, where, the pin is received within the radial through slot and where, when the toner detection window cleaning apparatus is inserted into a cartridge having a toner detection window, the cleaning member scrapes against at least a substantial portion of the toner detection window during at least part of one rotation of the rotatable shaft.

2. A toner detection window cleaning apparatus according to claim 1, where the cleaning member is “L”-shaped.

3. A toner detection window cleaning apparatus according to claim 1 where the rotatable shaft also has a toner agitator attached thereto.

4. A toner detection window cleaning apparatus according to claim 3, where the flange also has a connecting lug to which a helical agitating wire connects at a first end.

5. A cartridge including a toner detection window cleaning apparatus according to claim 1.
